(19) United States
(12) Patent Application Publication
(10) Pub. No.: US 2024/0288322 A1
(43) Pub. Date: Aug. 29, 2024

(54) Vibrating Bridge for a Vibrating-Wire Sensor, and Vibrating-Wire Sensor

(71) Applicant: Digi Sens AG, Murten (CH)

(72) Inventor: Ingo Leonard, Courlevon (CH)

(73) Assignee: Digi Sens AG, Murten (CH)

(21) Appl. No.: 18/572,105

(22) PCT Filed: Jun. 21, 2022
(86) PCT No.: PCT/CH2022/050012

§ 371 Date: Dec. 19, 2023

(30) Foreign Application Priority Data
Jun. 23, 2021 (CH) 00730/21

(51) Int. Cl. G01L 1/10; G01L 1/16

(52) U.S. Cl. CPC G01L 1/106; G01L 1/162

(57) ABSTRACT

The invention relates to a vibrating bridge for a vibrating-wire sensor, comprising opposing clamping points for connecting the vibrating bridge to the vibrating-wire sensor and comprising multiple vibrators which are provided between the clamping points and which are mechanically connected to the securing points and can be tensioned via the securing points, wherein one of the vibrators is free of a vibration exciter or vibration detector, and another vibrator is provided with a vibration exciter.

The present invention relates to a vibrating bridge for a vibrating-wire sensor according to the preamble of claim 1 and a vibrating-wire sensor according to the preamble of claims 13 and 14.

Vibrating-wire sensors are well-known and widely used for many metrological applications. According to the basic principle, a vibrating-wire sensor comprises a mechanical system in which a vibrating wire is tensioned, wherein the tension of the vibrating wire is generated by an elastic deformation of the mechanical system.

The mechanical system, on the other hand, can be arranged at two measuring points on a component of any kind or on a machine element, thus reducing its deformation due to the mutual displacement of the measuring points. This deformation path causes an elastic deformation of the mechanical system of the vibrating-wire sensor, which, in turn, causes a change in tension in the vibrating wire. With the changed tension, the resonance frequency of the vibrating wire, which is made to vibrate during operation by an exciter assembly, changes, which, in turn, can be detected by an evaluation assembly. Thus, a certain resonance frequency of the vibrating wire corresponds to a certain displacement of the measuring points.

The person skilled in the art is aware that the vibrating-wire sensor can be used for precise displacement measurement at a range in micrometres to nanometres due to the high Q-factor or the high quality of the vibrating wire. It is also known that force measurement can also be made by determining the force acting on the mechanical system since a certain force is required for a certain elastic deformation of the mechanical system. The Q-factor or quality is a measure of the attenuation or energy loss of a system capable of vibrating. A high Q-factor means that the system—in this case the vibrating wire—is weakly attenuated so that it has a high amplitude in the resonance range, which makes it sharply definable.

Vibrating-wire sensors are correspondingly more precise than, for example, strain gauges, and have a higher resolution and lower creep behaviour in comparison. Conversely, vibrating-wire sensors are comparatively large and consist of many components; in addition, they absorb a comparatively large amount of electrical power during operation. In particular, vibrating-wire sensors based on the magnetic excitation of a vibrating wire have a comparatively energy-consuming, complex and voluminous assembly for generating the necessary magnetic field.

For this reason, there is a special focus on vibrating-wire sensors with metallic vibrating bridges, which, strictly speaking, can not comprise a (more or less) flexible vibrating wire but a spring-elastic vibrator with a higher spring constant but which, due to the basic functional principle of resonance excitation, are now classified as vibrating-wire sensors.

For example, instead of a vibrating wire clamped at both ends, vibrating bridges have one or a plurality of vibrating bars clamped at the end, next to each other, which vibrate out of phase so that the centre of gravity of the vibrating bridge itself hardly vibrates during operation, which in turn leads to lower electrical power consumption.

In addition to other excitation methods for the vibrating bars, piezo actuators arranged on it have become known. However, it has been shown that the application of piezoceramics to the vibrating bar introduces disturbing factors into the behaviour of the vibrating bridges, which, among other disadvantages, lead to inaccurate measured values (for displacement/force) and, above all, to a drift of the measured values over time so that the characteristic advantages of the vibrating-wire sensors are considerably reduced or lost. Reasons for this can be seen in the use of components and mounting materials on a vibrating bar, as these are subject to a change in mass due to water absorption or outgassing, a change in elasticity due to temperature or ageing, which changes the resonance behaviour of the vibrating bar, and ultimately can also cause an undesirable stiffening of the vibrating bar that affects the resonance frequency.

CA 2 619 996 discloses a vibrating bridge for a vibrating-wire sensor with three vibrating bars next to each other, which are excited by a piezo actuator, wherein other piezo sensors pick up the current frequency of the vibrating bars. All piezo elements are located outside the vibrating bars near the clamping points of the vibrating bridge, which eliminates the disadvantages mentioned above so that accurate measured values can be expected. However, this assembly, in turn, leads to other disadvantages, which significantly worsen the accurate measurement or measurement precision that is possible with vibrating-wire sensors.

One of these disadvantages is the assembly of two piezoelectric elements as a vibration exciter and vibration detector directly next to each other so that an additional piezoelectric element must be provided as a second vibration detector so that a differential signal of the two vibration detectors can be formed, which is twice as strong and as the signal of only one vibration detector and thus suitable for further processing by an evaluation electronics and produces fewer errors.

According to the applicant's findings, other disadvantages are caused, for example, in that the disclosed assembly of the piezoelectric elements probably results in strong harmonics in the vibrating bar, and kinetic energy flows directly from the exciter element to the detector element or into the clamping points of the vibrating bridge. Other causes for the unfavourable behaviour of the disclosed order have remained unclear.

Thus, despite the assembly of piezoelectric elements possible in this way, it is still the case that the measurement precision of the vibrating bridge disclosed in CA 2 619 996 does not reach the quality possible with vibrating-wire sensors, although the critical assembly of the piezo elements on the vibrating bars is avoided.

Accordingly, the object of the present invention is to provide a vibrating bridge or a vibrating-wire sensor that achieves a high and constant measuring precision.

This task is achieved by means of a vibrating bridge with the features of claim 1 and by a vibrating-wire sensor with the features of claims 13 and 14.

Because one of the vibrators is free of an exciter element or vibration detector, it can be used as a resonance vibrator whose resonance properties are unaffected, which therefore has a high Q-factor and thus basically allows optimal measurement precision. Due to the assembly of the vibration-exciter element on another vibrator, which acts as an exciter vibrator, there is surprisingly no negative impact on the excitation and the resonance behaviour of the resonance vibrator itself, despite the predictably negatively impacted vibration behaviour of the exciter vibrator. The same also applies, just as surprisingly, to the assembly of a vibration-detector element on a detector vibrator. As a result, the highest measurement precision achievable by vibrating-wire sensors can be achieved by means of a vibrating bridge according to the invention, wherein a drift of the measured values is also dispensed with.

In addition to the proposed object, the time interval of individual measurements can be shortened by an exciter assembly according to claim 14, since a repetitive frequency search for the respective resonance frequency is largely dispensed with.

Other preferred embodiments have the features of the dependent claims.

The present invention is described in somewhat more detail in the following based on the figures.

The figures show:

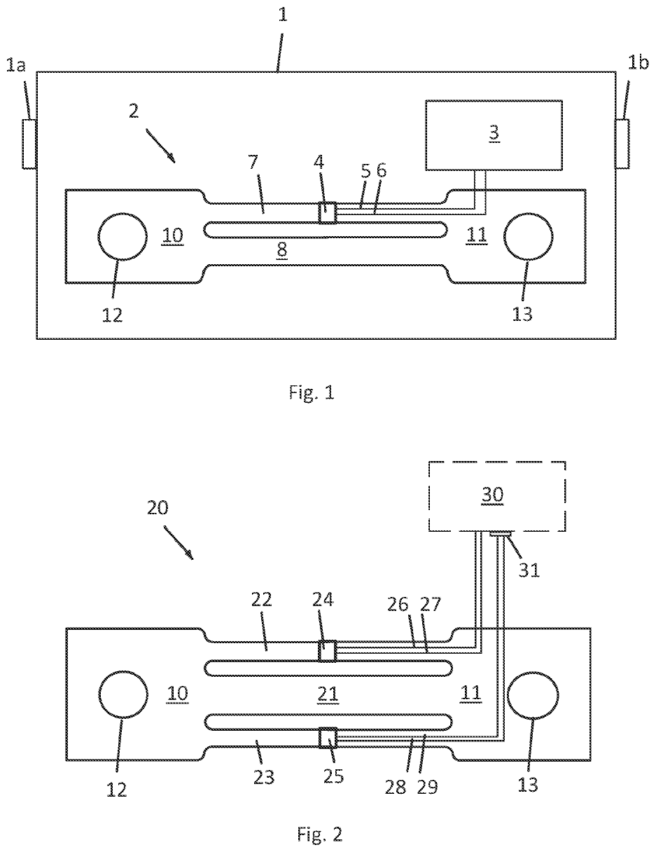

FIG. 1 schematically, a first embodiment of a vibrating bridge according to the invention,

FIG. 2 schematically, a second embodiment of a vibrating bridge according to the invention,

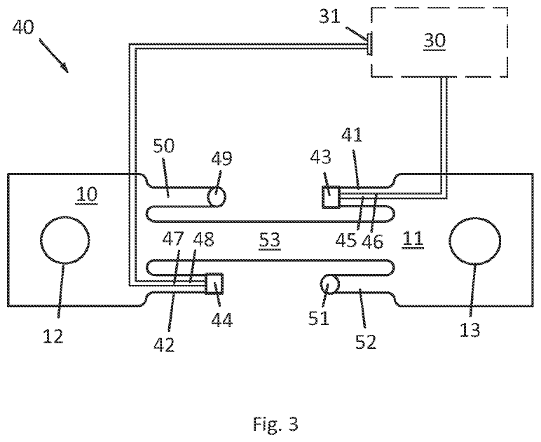

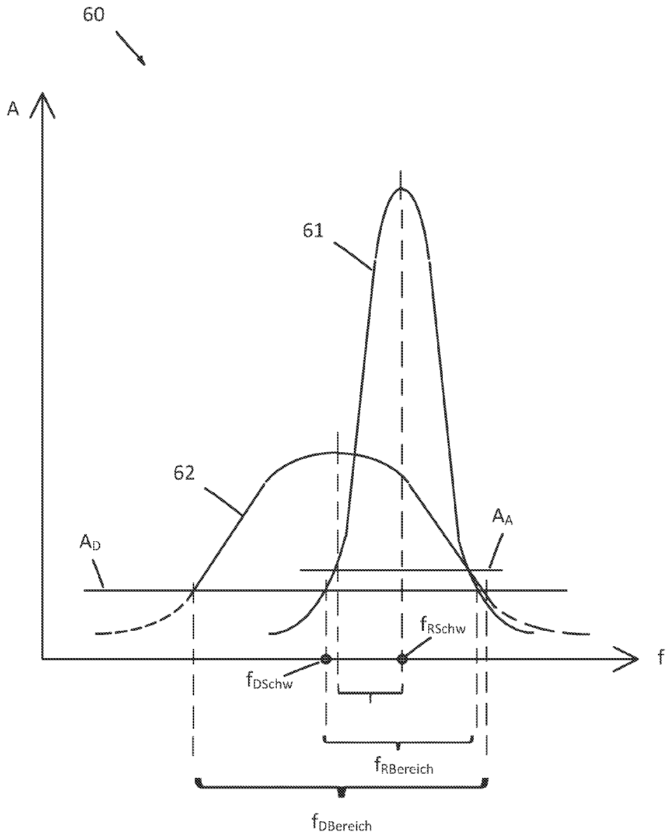

FIG. 3 schematically, a third embodiment of a vibrating bridge according to the invention, and

FIG. 4 schematic diagram of a vibrating-wire sensor with an embodiment of an bridge according to the invention comprising a vibration exciter and a vibration detector with different resonance frequencies.

FIG. 1 schematically shows a vibrating-wire sensor 1 with connection points 1a and 1b for its determination at measuring points of a component or machine part of any kind. Furthermore, the vibrating-wire sensor 1 is provided with a vibrating bridge 2 and an electronic exciter assembly 3 for a vibration-exciter element designed here as piezoelectric actuator 4, wherein the actuator 4 is connected to the exciter assembly 3 via wires 5, 6.

In the embodiment shown, the vibrating bridge 2 comprises a vibrator designed as exciter vibrator 7 and a vibrator designed as resonance vibrator 8 in the form of a vibrating bar, for example, rectangular in its cross-section. Connected to these, there is a left 10 and a right base section 11 of the vibrating bridge 2, between which the exciter vibrator 7 and the resonance vibrator 8 extend. In each base section 10, 11 a clamping point 12, 13 is provided for the clamping of the vibrating bridge 2 into a mechanical system of the vibrating-wire sensor 1 (not shown in the figure to not overburden it but principally known to the person skilled in the art). Via the base sections 10, 11, the exciter vibrator 7 and the resonance vibrator 8 are mechanically connected to the opposite clamping points 12, 13. The exciter vibrator 7 and the resonance vibrator 8 itself have basically the same resonance frequency and the same Q-factor, since they are made of the same material here (but not necessarily for all embodiments); furthermore, they are exposed to the same tensile stress during operation. However, the Q-factor of the exciter vibrator 7 is considerably reduced by the actuator 4 mounted on it, wherein its resonance frequency is also subject to drift for the reasons mentioned at the beginning.

During operation of a vibrating-wire sensor 1, the exciter assembly 3 performs a frequency search by applying a tension to the piezoelectric actuator 4 via the lines 5, 6 with a frequency that changes continuously in a predetermined frequency range (the exciter signal). As a result, the actuator 4 sets the exciter vibrator 7 into a forced vibration, wherein this, in turn, excites the resonance vibrator 8 via the adjacent areas of the base sections 10, 11. As a result, this resonates as soon as the frequency generated by the exciter assembly 3 or the frequency of the exciter signal corresponds to its current resonance frequency, which, in turn, is given by the tensile stress of the resonance vibrator 8 currently caused by the clamping points 12, 13.

In the embodiment shown, the exciter assembly 3 cycles between an excitation phase and a detection phase during the frequency search, i.e., a phase following the excitation phase without excitation.

In the respective detection phase, the forced vibration of the exciter vibrator 7 subsides quickly due to its attenuation, unless it is now, in turn, significantly excited by the resonance vibrator 8 (via the adjacent areas of the base sections 10, 11), but this is only the case if it is resonating (and as long as its amplitude is still large enough for this for a short time, which is the case for a long enough time). This excitation in turn generates an alternating tension via the piezo effect in actuator 4, which is applied to the exciter assembly 3 during the detection phase via the lines 5, 6 and represents a frequency and amplitude signal of the current vibration frequency of the exciter vibrator 7 (the detector signal). Based on its large amplitude, this detector signal detects that the resonance vibrator is resonating and what the resonance frequency is. During the detection phase, the exciter assembly 3 detects whether the resonance vibrator 8 is resonating or not. If this is the case, it detects its current resonance frequency. It is preferable that the vibration exciter (in the case of the embodiment shown due to its piezoelectric properties) can also be operated as a vibration detector.

Furthermore, the exciter assembly 3 can now be designed by means of a suitable vibration circuit in such a way that, in the case of a detected resonance frequency of the resonance vibrator 8, this frequency is used for the excitation phase following the detection phase so that the frequency search is interrupted and the exciter vibrator 7 is continuously maintained in a state of forced vibration with the current resonance frequency of the resonance vibrator 8. On the one hand, this compensates for the attenuation in the resonance vibrator 8 so that its amplitude does not drop.

On the other hand, a changing resonance frequency can also be tracked: If the tensile stress of the resonance vibrator 8 changes, it will continue to vibrate automatically at the new resonance frequency in the following phase at the latest without excitation due to the vibrational energy contained in it. In this detection phase, this also applies (via the adjacent regions of the base sections 10, 11) to the exciter vibrator 7, wherein the changed frequency is again detected by the exciter assembly 3 as a new resonance frequency and used to excite the exciter vibrator in the next phase of excitation.

With this feedback of the resonance frequency, a changing tensile stress of the vibrating bridge 2 can be quickly tracked—a time-consuming, new frequency search is no longer necessary. However, if the change in the tensile stress is too abrupt, the resonance frequency will no longer be detected. The frequency search can then simply be restarted. The result is a vibrating-wire sensor with a vibrating bridge, which preferably has an exciter assembly for the vibration-exciter element, which is designed to detect a current detection signal generated by the vibration-exciter element during a detection phase of the vibration-exciter element. Furthermore, the exciter assembly is preferentially designed, during an excitation phase following a detection phase, to excite the vibration-exciter element by means of the exciter signal at a frequency that corresponds to the detector signal generated by it during the preceding detection phase.

This cycle of “excite/detect” of the exciter assembly 3 is repeated during the entire frequency search run, preferably for each search frequency. The same applies to the frequency search as such, in order to determine a resonance of the resonance vibrator even with strongly or abruptly changing tensile stress of the vibrating bridge 2 if a changed resonance frequency should no longer be detectable due to the feedback.

Instead of a frequency search, it is also possible to apply a single excitation pulse (Heaviside pulse) to the exciter vibrator 7 as an exciter signal. In a Heaviside pulse, all frequencies are represented. As a result, the resonance vibrator 8 is excited in its resonance frequency so that in the subsequent detection phase, for example, a piezoelectric element such as actuator 4 can generate the corresponding detector signal and transmit it to the exciter assembly 3. It is possible for the person skilled in the art to supply a voltage-jump function to a piezo element via the corresponding formation of the electronics so that a Heaviside pulse is transmitted to the exciter vibrator 7.

An evaluation unit of the vibrating-wire sensor, which is not shown for the purpose of relief, but which is generally known to the person skilled in the art and preferably provided for in exciter assembly 3, outputs a measured value for the desired force/displacement measurement on the basis of the detected resonance frequency of the resonance vibrator 8.

It is true that the exciter vibrator 7 seems to have deteriorated properties due to the piezoelectric element 4 attached to it for a resonance measurement, in particular, the reduced Q-factor (increased attenuation) so that its resonance curve still comprises large amplitudes around the resonance frequency across a wide range (in contrast to very rapidly decreasing amplitude around the resonance frequency with only low attenuation, as is the case with the resonance vibrator) as well as a drift of its own resonance frequency for the reasons given at the beginning (change in mass, local stiffening with changing properties of the adhesive, etc.). Due to these quality losses, the exciter vibrator 7 can also comprise notable amplitudes outside the resonance frequency of the resonance vibrator 8, but this does not bother due to the high Q-factor of the resonance vibrator 8 since it does not have any notable amplitude e outside its resonance frequency, and thus has too little vibration energy during the detection phase to excite the exciter vibrator 7 strongly enough for a resonance frequency signal.

On the contrary, the reduced Q-factor of the exciter vibrator 7 can have a positive impact due to a wide range of high amplitude around its resonance frequency if the resonance frequencies of the two vibrators deviate 7, 8 from each other. For example, this occurs if the tensile stresses in the vibrators 7, 8 deviate from each other due to a non-ideal installation, for example, if the clamping points are not screwed together ideally so that a torque is generated in the base sections, or because of temperature stresses after welding. Then, despite the different resonance frequencies, the amplitude of the exciter vibrator 7 in the resonance range of the resonance vibrator 8 is still high enough to be able to excite it sufficiently enough that it can resonate (see also the description of FIG. 4).

On the other hand, however, the negative effects of the placement of a vibration exciter in the base section, as is disclosed in CA 2 619 996 mentioned at the beginning, thereby resulting in the generation of considerable and thus disturbing harmonics and the outflow of kinetic energy via the nearby clamping point, etc., are eliminated.

FIG. 2 shows a further embodiment of a vibrating bridge 20 according to the invention, which instead of two has three parallel vibrators arranged in a common plane, namely a resonance vibrator 21 in the middle, a lateral exciter vibrator 22 and a detector vibrator 23 located on the other side of the resonance vibrator 21.

On the exciter vibrator there is a vibration-exciter element also designed as a piezoelectric actuator 24, on the detector vibrator 23 a vibration detector 25 designed as piezoelectric element. Lines 26, 27 and 28, 29 connect the actuator 24 and the detector 25 with an exciter assembly 30, which is symbolic and shown in using dashes. In order not to overburden figure, the vibrating-wire sensor itself, in which the vibrating bridge 20 is installed, is not shown. Again, a frequency search is carried out during operation via the exciter assembly 30, wherein a detection phase corresponding to the embodiment shown in FIG. 2 is dispensed with since the vibration detector 25 detects the frequency and amplitude of the detector vibrator 23 simultaneously with the excitation of the exciter vibrator 22, generates a corresponding detector signal and outputs it to an input 31 (schematically shown in the figure) for the detector signal to the exciter assembly 30 so that the exciter assembly 30 can process the detector signal.

If, during the frequency search, exciter vibrator 22 is excited by actuator 24, it is set into a forced vibration at the frequency specified by actuator 24. If this does not correspond to the resonance frequency of the resonance vibrator 21 within a narrow range that corresponds to the high Q-factor, the resonance vibrator 21 does not resonate, and the detector vibrator 23 does not resonate since there are no notable deformations of the boundary areas of the base sections 10, 11 between it and the resonance vibrator 21.

If, however, the actuator 24 hits the resonance frequency of the resonance vibrator 21 accurately enough during the frequency search, the latter begins to vibrate. Only then is sufficient energy transferred to the detector vibrator 23 so that it resonates. Its amplitude increases significantly, even if its Q-factor is reduced or there is a drift of its resonance frequency due to the detector vibrator 25 located on it. The vibration of the detector vibrator 23 is out of phase with the resonance vibrator 21, but at the same frequency as the resonance frequency of the resonance vibrator 21.

The vibration detector 25 now generates a detector signal for the amplitude of the detector vibrator 23, as well as its frequency, wherein the significant increase in amplitude shows that the corresponding frequency is the resonance frequency of the resonance vibrator 22. However, it should be noted again that the resonance frequency of the resonance vibrator 22 can also only be detected via the amplitude, as this corresponds to the frequency of the exciter signal. Preferably, however, the detector signal contains the amplitude and the frequency, and the resonance frequency is then the frequency of the detector signal at high amplitude. Once the resonance frequency of the resonance vibrator 22 has been found, the exciter assembly 3 can be used to maintain the current vibration amplitude at the resonance frequency of the resonance vibrator by means of a phase-correct feedback of the detector signal to the actuator 24, which thereby maintains the current vibration amplitude at the resonance frequency of the resonance vibrator. For this purpose, the person skilled in the art can provide exciter assembly 3 (as well as in the embodiment in accordance with FIG. 1) with a corresponding vibrator circuit. This also makes it possible to follow a change in the resonance frequency, as is the case with the embodiment of FIG. 1, wherein if the change is too strong, the frequency search can simply be restarted.

The start of the resonance vibration of the resonance vibrator 22 by a Heaviside impulse, which has already been described for the assembly of FIG. 1, is also possible here (as in all embodiments according to the invention).

In accordance with FIG. 2, there is a vibrating bridge in which three vibrators 21 to 23 are provided in a plane parallel to each other, one of the outer ones is provided with the vibration exciter 24 and the other with the vibration detector 25 and the middle vibrator 21 is free of these, wherein, preferably, the outer vibrators can also be subjected to tension. Furthermore, the middle vibrator 21 is completely uncovered, so it also comprises no coating or other element for any purpose. This means that the resonance vibrator is also free of any other element for any purpose (in addition to a vibration exciter or detector) and preferably uncoated.

A minimum energy consumption of the vibrating bridge 2.20 results if its centre of gravity remains essentially at rest during operation. Since the vibrators 7, 8 and 21 to 23 vibrate out of phase, it results in that, preferably, the mass of the outer vibrators 22, 23 with the vibration exciter 24 and—vibration detector 25 is essentially the same as the mass of the middle vibrator 21 and the vibrating bridge 20 is designed in such a way that in the case of an anti-phase vibration of the outer vibrators 22, 23 to the middle vibrator 21, the centre of gravity of the vibrating bridge 20 remains essentially at rest.

Preferably, the vibration exciter (actuators 4, 24 in FIGS. 1 and 2) is provided in the middle of the exciter vibrator 7, 22, which avoids the generation of disturbing harmonics in its vibration behaviour. This is also preferred for the vibration detector 25 on the detector.

FIG. 3 shows another embodiment of a vibrating bridge 40 for a vibrating-wire sensor. In contrast to the vibrating bridge 20 (FIG. 2), the exciter vibrator and the detector vibrator are not designed as vibrating bars but as vibrating tabs, in this case, as an exciter vibrating tab 41 and a detector vibrating tab 42, which preferably comprise a piezoelectric actuator 43 as a vibration-exciter element and a piezoelectric vibration detector 44 at their respective ends respectively, both of which are connected via corresponding wires 45, 46 and 47, 48 respectively with the exciter assembly 30, or their input 31 for the detector signal are operationally connected.

The exciter vibrating tab 41 is opposed by a compensating vibrating tab 50 with a compensating vibrating tab 49, and the detector vibrating tab 42 by a compensating vibrating tab 52 with a compensating vibrating tab 51. As a result, the vibrating bridge 40 as a whole remains better at rest during operation, as does its centre of gravity in particular. Again, the resonance vibrator 53 is free of vibration exciters or vibration detectors, and preferably free of other elements and also coatings of any kind. Frequency searching, generation of the detector signal and feedback are carried out in the same way as the embodiment in accordance with FIG. 1 and, in particular, with FIG. 2.

Compared to the embodiment of FIG. 2 (assuming the same mechanical system in the vibrating-wire sensor), the measuring range is half as large, since the tensile stress only has to be absorbed by the resonance vibrator 53—the resolution remains the same. However, since the measuring range is half as large, the result is twice as fine a resolution for this half measuring range.

It follows that the vibrator provided with the vibration exciter is preferably designed as a vibrating tab, wherein further preference is given to another vibrator designed as a vibrating tab, which has a vibration detector. Furthermore, a vibrator designed as a vibrating tab is preferably located opposite to a counter-vibrating tab. Ultimately, it is preferable to have a counter-vibrating tab with a weight that comprises such a mass that the counter-vibrating tab vibrates essentially at the same phase as the vibrating tab to which it is assigned during operation of the vibrating bridge.

According to the invention, the embodiments shown in FIGS. 1 to 3 have in common a vibrating bridge for a vibrating-wire sensor, with clamping points located opposite to one another for the connection of the vibrating bridge with the vibrating-wire sensor and comprising a plurality of vibrators provided between the clamping points, which are mechanically connected to the securing points, wherein at least one of the vibrators can be subjected to tension via them and is free of a vibration exciter or vibration detector and another vibrator is provided with a vibration exciter. More precisely and generally, a vibrating bridge for a vibrating-wire sensor with clamping points located opposite to one another for the connection of the vibrating bridge with the vibrating-wire sensor and with a plurality of vibrators provided between the clamping points, one of which is designed as a resonance vibrator, which are mechanically connected to the clamping points, wherein resonance vibrator is able to be subjected to tension via the clamping points and is free of a vibration exciter or vibration detector and on another vibrator a vibration exciter is arranged.

Preferably, at least one of the provided vibration exciters or detectors is designed as a piezoelectric element. Furthermore, at least one of the vibrators is preferably designed as an elongated rod, preferably as a square (being furthermore preferred, all vibrators of an embodiment are formed in the same way). It is preferable to have at least one of the vibrators, and even more preferably the vibrating bridge as a whole, is made of a metal, spring steel or other suitable material. Spring-elastic materials with low attenuation are suitable so that a resonance curve with a sharply definable resonance frequency is available over the steep amplitude increase. Preferably, the spring-elastic material also has a high yield strength, which then leads to a wide measuring range. However, it is preferred if this material is different from a piezoelectric material, as it is not intended to excite or detect itself but do this via vibration exciters or detectors, which allows more suitable materials to be used than piezoelectric materials.

Ultimately, according to the invention, a vibrating-wire sensor with a vibrating bridge is a vibrating-wire sensor that comprises an exciter assembly for the vibration exciter provided with an input for a frequency signal of the vibration detector, and the exciter assembly is designed to output a frequency corresponding to the frequency signal as an excitation frequency to the vibration exciter.

FIG. 4 shows a diagram 60 with the resonance curve 61 of a resonance vibrator 7,22,41 In accordance with FIGS. 1 to 3 and the resonance curve 62 of a detector vibrator 8, 23, 42 in accordance with FIGS. 1 to 3. The vertical axis denotes the amplitude A and the horizontal axis the frequency f of the vibration of the respective vibrator.

The diagram also shows a detection amplitude A_{D} of exciter assembly 3, 30, which indicates when an amplitude of the detector signal (resonance curve 62) is detected as an amplitude and processed as such or when it is discarded as an amplitude, for example, as mere noise in the detector signal (or for other reasons). Accordingly, the resonance curve 62 below the threshold of the detection amplitude A_{D} is no longer recognizable by a respective exciter assembly 3, 30 and is shown in dashed lines in FIG. 4.

The detection amplitude A_{D} is shown schematically in FIG. 4, depends on the assembly of the vibrating bridge, the vibration detector and the exciter assembly 3, 30 chosen by those skilled in the art in each specific case and does not have to be constant over the frequency range of interest, but is drawn as a straight line in FIG. 4 for the sake of simple representation.

The detection amplitude A_{D} is not relevant for the resonance curve 61 of the resonance vibrator 7, 22, 41, because it is not detected-accordingly the resonance curve 61 is shown without a dashed area. However, the detection amplitude A_{D} can also be used for the comparison of the resonance curves 61, 62, as a comparison is possible at the same amplitude. As described above, the resonance frequencies for the resonance vibrator 7, 22, 41 and f_{Dres} of the detector vibrator 8, 23, 42 are different here, wherein the resonance curve 61 of the resonance vibrator 7, 22, 41 has a narrow frequency range due to its high Q-factor and the resonance curve 62 of the detector vibrator 8, 23, 42 has a wider frequency range due to its lower Q-factor. As a result, the resonance curve 62 is flatter than the resonance curve 61. By excitation in the resonance frequency range f_{RRange}, reached by the piezoelectric actuator 4,24,43, the amplitude of the resonance vibrator 7,22,41 increases and transfers more energy to the detector vibrator 8,23,42, whose amplitude also increases until it exceeds the detection amplitude A_{D}. The necessary amplitude of the resonance vibrator 7, 22, 41, the transmission amplitude A_{A}, depends on the specific formation of the vibrating bridge 1. If the transmission amplitude A_{A} is exceeded, the corresponding frequency range of the resonance vibrator 7, 22, 41 results in a vibration of the detector vibrator 8, 23, 42 according to the resonance curve 62, which in turn, since it is above the detection amplitude A_{D}, can be detected by the exciter assembly 3, 30. In other words, in order to determine the resonance frequency of the resonance vibrator 7, 22, 41 by the exciter assembly 3, 30, the resonance curve 61 of the resonance vibrator 7, 22, 41 above the transmission amplitude A_{A} and the resonance curve 62 of the detector vibrator 8, 23, 42 above the detection amplitude A_{D} must preferably overlap, i.e., have at least one common frequency, preferably a common frequency range. Preferably, the vibrating bridge 1 and the exciter assembly 3, 30 are designed in such a way that the detection amplitude A_{D} and the transmission amplitude A_{A} coincide in order to keep the possible overlap area as largest.

This means that a divergence of the resonance frequencies (e.g., due to assembly errors or other reasons) and a lower Q-factor of the detector vibrator 8, 23, 42 are problem-free as long as the overlap is present. A low Q-factor is therefore quite desirable, because a flatter resonance curve 62 allows a greater deviation of the resonance frequencies. This results in a vibrating-wire sensor 1 with a vibrating bridge 20, 40 according to claim 1, wherein the vibrating bridge 20, 40 furthermore comprises a detector vibrator 23, 42 with a resonance frequency f_{Dres} different from the resonance frequency f_{Rres} for the resonance vibrator 21, 53, and with a resonance curve 62 which is flatter than the resonance curve 61 of the resonance vibrator 21, 53, and the vibrating bridge 20, 40 is designed in such a way that the detector vibrator 23, 42 vibrates during operation at a vibration of the resonance vibrator 21, 53 at an amplitude above a transmission amplitude A_{A} at an amplitude above a detection amplitude A_{D} of the exciter assembly 30, and that the vibrating-wire sensor 1 is provided with an exciter assembly 30, which is designed to generate an exciter signal for a vibration exciter 24, 44 and to process a currently detected detector signal of a vibration detector 25,45 arranged on the detector vibrator 23, 42, thereby not using this detector signal for the determination of the frequency and amplitude of the detector vibrator 7, 23, 42 below the detection amplitude A_{D}, wherein the resonance curves 61, 62 of the resonance vibrator (21, 53) and the detector vibrator (23, 42) overlap in the range above the higher value of the detection amplitude A_{D} and the transmission amplitude A_{A}. With such a vibrating-wire sensor, intentionally or unintentionally, different resonance frequencies 61, 62 and a lower Q-factor of the detector vibrator are permissible. In a preferred embodiment, exciter assembly 30 is furthermore designed not to use the currently detected detector signal for the determination of the frequency and amplitude of the detector vibrator 7, 23, 42 if its frequency is not within a predetermined permissible frequency range within the frequency range of the resonance vibrator the above transmission amplitude A_{A}. This means that a vibration of the detector vibrator 23, 42 that is not triggered by the resonance vibrator 21, 53 can be discarded from the outset.

1. A vibrating bridge for a vibrating-wire sensor with clamping points located opposite to one another for connecting the vibrating bridge to the vibrating-wire sensor and to a plurality of vibrators provided between the clamping points, one of which is designed as a resonance vibrator mechanically connected to the clamping points, wherein the resonance vibrator is subjected to tension or pressure during operation via the clamping points, characterized in that the resonance vibrator is free of a vibration exciter or a vibration detector, and another vibrator is provided with a vibration exciter.

2. The vibrating bridge according to claim 1, wherein the vibration exciter can be operated as a vibration detector.

3. The vibrating bridge according to claim 1, wherein three vibrators are provided parallel to each other on a plane, one of the outer ones being provided with the vibration exciter and the other with the vibration detector, and at least the middle one can be subjected to tension and is free of these, wherein, preferably, the outer vibrators can also be subjected to tension.

4. The vibrating bridge according to claim 3, wherein the mass of the outer vibrators with the vibration exciter and the vibration detector is essentially the same as the mass of the middle vibrator and the vibrating bridge, being designed in such a way that, in the event of an out-of-phase vibration of the outer vibrators to the middle vibrator, the centre of gravity of the vibrating bridge remains essentially at rest.

5. The vibrating bridge according to claim 1, wherein the vibrator provided with the vibration exciter is designed as a vibrating tab.

6. The vibrating bridge according to claim 1, wherein a further vibrator designed as a vibrating tab is provided, which comprises a vibration detector.

7. The vibrating bridge according to claim 5, wherein a vibrator designed as a vibrating tab is located opposite to a counter-vibrating tab.

8. The vibrating bridge according to claim 7, wherein a counter-tab is provided with a weight which has such a mass that the counter-tab vibrates during operation of the vibrating bridge with essentially the same phase as the tab to which it is assigned.

9. The vibrating bridge according to claim 1, wherein at least one of the provided vibration exciters or collectors is designed as piezoceramics.

10. The vibrating bridge according to claim 1, wherein at least one of the vibrators, preferably the vibrating bridge, consists of a material different from a piezoelectric material, being especially preferred, made of metal, preferably made of spring steel.

11. The vibrating bridge according to claim 1, wherein at least one of the vibrators is designed as an elongated rod, preferably as a square.

12. The vibrating bridge according to claim 3, wherein the vibration exciter and the vibration detector are provided in the middle of the vibrator assigned to it.

13. The vibrating bridge according to claim 1, wherein the resonance vibrator is furthermore free of any other element for any purpose and is preferably uncoated.

14. A vibrating-wire sensor with a vibrating bridge according to claim 1, wherein this comprises an exciter assembly for the vibration exciter provided with an input for a frequency signal of the vibration detector, and the exciter assembly is designed to output a frequency corresponding to the frequency signal as an excitation frequency to the vibration exciter.

15. A vibrating-wire sensor with a vibrating bridge according to claim 1, wherein this comprises an exciter assembly for the vibration-exciter element, which is designed to detect a current detection signal generated by the vibration-exciter element during a phase without excitation of the vibration-exciter element.

16. The vibrating-wire sensor according to claim 15, wherein the exciter assembly is furthermore designed, during an excitation phase of the vibration-exciter element following the phase without excitation, to excite it by means of the exciter signal at a frequency which corresponds to the detection signal generated by it in the preceding phase without excitation.

17. The vibrating-wire sensor with a vibrating bridge according to claim 1, wherein the vibrating bridge furthermore comprises a detector vibrator with a resonance frequency f_{Dres} different from the resonance frequency f_{Rres} for the resonance vibrator, and with a resonance curve which is flatter than the resonance curve of the resonance vibrator, and the vibrating bridge is designed in such a way that the detector vibrator vibrates during operation at a vibration of the resonance vibrator at an amplitude above a transmission amplitude A_{A}, in turn, at an amplitude above a detection amplitude A_{D} of the exciter assembly, and the vibrating-wire sensor is provided with an exciter assembly which is designed to generate an exciter signal for a vibration exciter and process a currently detected detector signal of a vibration detector arranged on the detector vibrator, thereby not using this detector signal to determine the frequency and amplitude of the detector vibrator below the detection amplitude A_{D}, wherein the resonance curves of the resonance vibrator and the detector vibrator overlap in the range above the higher value of the detection amplitude A_{D} and the transmission amplitude A_{A}.

18. The vibrating-wire sensor according to claim 16, wherein the exciter assembly is furthermore designed not to use the currently detected detector signal for the determination of the frequency and amplitude of the detector vibrator if its frequency is not within a predetermined permissible frequency range within the frequency range of the resonance vibrators above the transmission amplitude A_{A}.
